(19) United States
(12) Patent Application Publication
(10) Pub. No.: US 2019/0273262 A1
(43) Pub. Date: Sep. 5, 2019

(54) SECONDARY BATTERY AND METHOD OF MANUFACTURING SECONDARY BATTERY

(71) Applicant: SANYO Electric Co., Ltd., Osaka (JP)

(72) Inventors: Yoshitaka Matsumasa, Hyogo (JP); Tomokazu Yamanaka, Hyogo (JP)

(73) Assignee: SANYO Electric Co., Ltd., Osaka (JP)

(21) Appl. No.: 16/254,833

(22) Filed: Jan. 23, 2019

(30) Foreign Application Priority Data
Mar. 2, 2018 (JP) 2018-037099

(51) Int. Cl. H01M 4/70; H01M 4/66; H01M 4/04; B23K 20/02; H01M 4/131; H01M 10/0525

(52) U.S. Cl. CPC H01M 4/70; H01M 4/661; H01M 4/04; H01M 2004/021; H01M 4/131; H01M 10/0525; B23K 20/023

(57) ABSTRACT

A secondary battery includes a positive electrode plate including a positive electrode core body on which a positive electrode active material layer is formed and a positive electrode current collector joined to the positive electrode core body. The layered positive electrode core body includes a joined portion joined to a positive electrode current collector. When the product of the thickness of one layer of a portion of the positive electrode core body not joined to the positive electrode current collector and the number of layers of the positive electrode core body at the joined portion is Tₚ1, the joined portion includes a first region having a thickness less than Tₚ1 and a second region having a thickness more than Tₚ1 in a layered direction of the positive electrode core body.

### CROSS REFERENCE TO RELATED APPLICATIONS:

The present invention application claims priority to Japanese Patent Application No. 2018-037099 filed in the Japan Patent Office on Mar. 2, 2018, the entire contents of which are incorporated herein by reference.

### BACKGROUND OF THE INVENTION

### Field of the Invention

The present invention relates to a secondary battery and a method of manufacturing the secondary battery.

### Description of Related Art

Secondary batteries such as nonaqueous electrolyte secondary batteries are used in hybrid electric vehicles, electric vehicles, large-sized power storage systems, and the like.

These secondary batteries each include an electrode body including a positive electrode plate having a positive electrode active material layer on a positive electrode core body made of metal and a negative electrode plate having a negative electrode active material layer on a negative electrode core body made of metal, the positive electrode plate and the negative electrode plate being layered or wound via a separator.

A positive electrode current collector electrically connected to a positive electrode terminal is connected to the layered positive electrode core body, and a negative electrode current collector electrically connected to a negative electrode terminal is connected to the layered negative electrode core body.

As a method of connecting a positive electrode current collector and as a positive electrode core body to each other and a method of connecting a negative electrode current collector and a negative electrode core body to each other, ultrasonic joining, resistance welding, laser welding, or the like is employed (Japanese Patent No. 5472687 (Patent Document 1), Japanese Published Unexamined Patent Application No. 2009-047609 (Patent Document 2)).

### BRIEF SUMMARY OF THE INVENTION

An object of the present invention is to provide a secondary battery that includes a highly-reliable joined portion between a current collector and a layered core body.

A secondary battery according to an embodiment of the present invention is a secondary battery including a first electrode plate that includes a first core body made of metal and a first active material layer disposed on the first core body, the first core body being layered; and a first current collector made of metal and joined to the layered first core body, in which the layered first core body includes a joined portion that is joined to the first current collector and in which, when a product of a thickness of one layer of the first core body at a portion not joined to the first current collector and the number of layers of the first core body at the joined portion is T1, the joined portion includes a first region having a thickness less than T1 and a second region having a thickness more than T1 in a layered direction of the first core body.

The configuration of the secondary battery according to an embodiment of the present invention enables the secondary battery to include a highly-reliable joined portion between a current collector and a layered core body.

A method of manufacturing a secondary battery according to an embodiment of the present invention is a method of manufacturing a secondary battery including a first electrode plate that includes a first core body made of metal and a first active material layer disposed on the first core body, the first core body being layered, and a first current collector made of metal and joined to the layered first core body, the method including a first process of arranging the first current collector on an outer surface of the layered first core body and a second process of joining the layered first core body and the first current collector to each other by applying ultrasonic vibrations to the layered first core body and the first current collector held between an anvil and a horn, thereby providing the layered first core body with a joined portion joined to the first current collector, in which, when a product of a thickness of one layer of the first core body before being joined and the number of layers of the first core body at the joined portion is T1, a first region having a thickness less than T1 and a second region having a thickness more than T1 are formed in the joined portion in a layered direction of the first core body as a result of the second process.

The method of manufacturing the secondary battery according to an embodiment of the present invention provides a secondary battery that includes a highly-reliable joined portion between a current collector and a layered core body.

It is possible to provide a secondary battery that includes a highly-reliable joined portion between a current collector and a layered core body.

### BRIEF DESCRIPTION OF THE SEVERAL VIEWS OF THE DRAWINGS:

FIG. 1 is a front view illustrating a battery inner portion of a secondary battery according to an embodiment by omitting a front part of a battery case and a front part of an insulating sheet.

FIG. 2 is a top view of the secondary battery according to the embodiment.

FIG. 3A is a plan view of a positive electrode plate according to the embodiment.

FIG. 3B is a plan view of a negative electrode plate according to the embodiment.

FIG. 4 illustrates a state in which a layered core body and a current collector are held between a horn and an anvil.

FIG. 5A and FIG. 5B illustrate the vicinity of a joined portion between a positive electrode current collector and a layered positive electrode core body, FIG. 5A illustrating a surface on the positive electrode core body side, FIG. 5B illustrating a surface on the positive electrode current collector side.

FIG. 6 is a sectional view taken along line VI-VI in FIG. 5A.

FIG. 7A and FIG. 7B illustrate the vicinity of a joined portion between a negative electrode current collector and a layered negative electrode core body, FIG. 7A illustrating a surface on the negative electrode core body side, FIG. 7B illustrating a surface on the negative electrode current collector side.

FIG. 8 is a sectional view taken along line VIII-VIII in FIG. 7A.

### DETAILED DESCRIPTION OF THE INVENTION

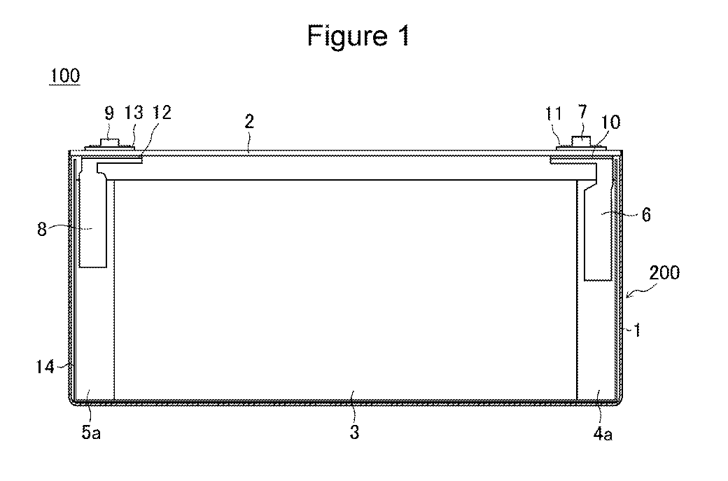

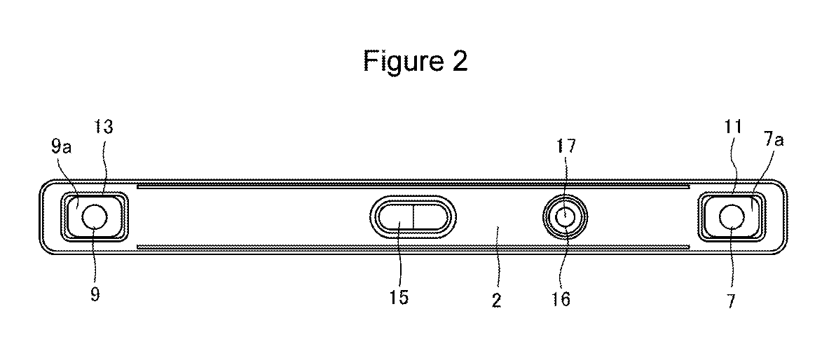

Hereinafter, an embodiment of the present invention will be described. Note that the present invention is not limited to the following form. First, the configuration of a rectangular secondary battery 100 according to an embodiment will be described with reference to FIG. 1 and FIG. 2.

As illustrated in FIG. 1 and FIG. 2, the rectangular secondary battery 100 includes a rectangular exterior body 1 having an opening in an upper portion thereof and a sealing plate 2 that seals the opening. The rectangular exterior body 1 and the sealing plate 2 constitute a battery case 200. The rectangular exterior body 1 and the sealing plate 2 are each made of metal and preferably made of aluminum or an aluminum alloy. A flat wound electrode body 3 including a positive electrode plate and a negative electrode plate (both not illustrated) that are wound via separator (not illustrated) is housed together with a nonaqueous electrolyte inside the rectangular exterior body 1. The positive electrode plate includes a positive electrode core body made of metal and on which a positive electrode active material layer containing a positive electrode active material is disposed and includes a positive-electrode-core-body exposure portion at which the positive electrode core body is exposed in a longitudinal direction. The negative electrode plate includes a negative electrode core body made of metal and on which a negative electrode active material layer containing a negative electrode active material is disposed and includes a negative-electrode-core-body exposure portion at which the negative electrode core body is exposed in the longitudinal direction. Preferably, the positive electrode core body is made of aluminum or an aluminum alloy, and the negative electrode core body is made of copper or a copper alloy.

A positive electrode core body 4a on which no positive electrode active material layer is formed is arranged in a layered state on one end side of the wound electrode body 3 in a direction in which a winding axis extends. The positive electrode core body 4a is in the layered state by being wound. A positive electrode current collector 6 is connected to the layered positive electrode core body 4a. Preferably, the positive electrode current collector 6 is made of aluminum or an aluminum alloy.

A negative electrode core body 5a on which no negative electrode active material layer is formed is arranged in a layered state on the other end side of the wound electrode body 3 in the direction in which the winding axis extends. The negative electrode core body 5a is in the layered stated by being wound. A negative electrode current collector 8 is connected to the layered negative electrode core body 5a. Preferably, the negative electrode current collector 8 is made of copper or a copper alloy.

A positive electrode terminal 7 includes a flange portion 7a arranged on the sealing plate 2 on the external side of the battery and an insertion portion inserted into a through hole provided in the sealing plate 2. The positive electrode terminal 7 is made of metal and preferably made of aluminum or an aluminum alloy. A negative electrode terminal 9 includes a flange portion 9a arranged on the sealing plate 2 on the external side of the battery and an insertion portion inserted into a through hole provided in the sealing plate 2. The negative electrode terminal 9 is made of metal and preferably made of copper or a copper alloy. The negative electrode terminal 9 may include a portion made of aluminum or an aluminum alloy and a portion made of copper or a copper alloy. In this case, preferably, the portion made of aluminum or an aluminum alloy projects outward from the sealing plate 2 and the portion made of copper or a copper alloy is connected to the negative electrode current collector 8.

The positive electrode current collector 6 and the positive electrode terminal 7 are fixed to the sealing plate 2 via an internal insulating member 10 made of resin and an external insulating member 11 made of resin, respectively. The negative electrode current collector 8 and the negative electrode terminal 9 are fixed to the sealing plate 2 via an internal insulating member 12 made of resin and an external insulating member 13 made of resin, respectively. The internal insulating member 10 is arranged between the sealing plate 2 and the positive electrode current collector 6, and the external insulating member 11 is arranged between the sealing plate 2 and the positive electrode terminal 7. The internal insulating member 12 is arranged between the sealing plate 2 and the negative electrode current collector 8, and the external insulating member 13 is arranged between the sealing plate 2 and the negative electrode terminal 9. The wound electrode body 3 is covered with an insulating sheet 14 and housed inside the rectangular exterior body 1 in the covered state. The sealing plate 2 is connected to an edge portion of the opening of the rectangular exterior body 1 by laser welding or the like. The sealing plate 2 has an electrolytic solution injection hole 16. The electrolytic solution injection hole 16 is sealed by using a sealing plug 17 after an electrolytic solution is injected. The sealing plate 2 is provided with a gas discharging valve 15 for discharging gas when the pressure of an internal portion of the battery becomes a predetermined value or more.

### Manufacture of Electrode Body

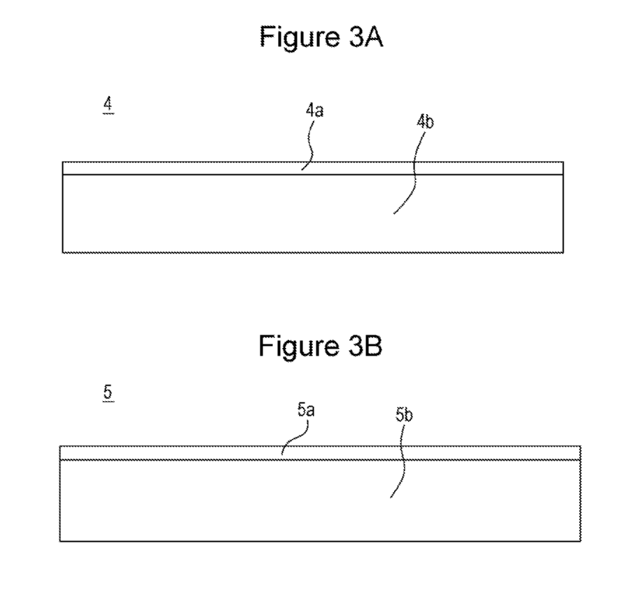

Next, a method of manufacturing the wound electrode body 3 will be described. Positive electrode mixture slurry that contains a lithium-nickel-cobalt-manganese composite oxide, as the positive electrode active material, a conductive agent, a binder, and a dispersion medium is produced. Next, the positive electrode mixture slurry is applied on both surfaces of a belt-shaped aluminum foil, as the positive electrode core body 4a, having a thickness of 15 μm. Next, the positive electrode mixture slurry is dried to remove the dispersion medium. Consequently, a positive electrode active material layer 4b is formed on both surfaces of the positive electrode core body 4a. Next, the positive electrode active material layer 4b is compressed to a predetermined packing density, thereby obtaining a positive electrode plate 4. FIG. 3A is a plan view of the positive electrode plate 4. The positive electrode plate 4 includes, at an end portion on one side in a short-side direction, a positive-electrode-core-body exposure portion having a predetermined width and on which the positive electrode active material layer 4b is not disposed.

Negative electrode mixture slurry that contains graphite powder, as the negative electrode active material, a binder, and a dispersion medium is produced. Next, the negative electrode mixture slurry is applied on both surfaces of a belt-shaped copper foil, as the negative electrode core body 5a, having a thickness of 8 μm. Next, the negative electrode mixture slurry is dried to remove the dispersion medium. Consequently, a negative electrode active material layer 5b is formed on both surfaces of the negative electrode core body 5a.

Next, the negative electrode active material layer 5b is compressed to a predetermined packing density, thereby obtaining a negative electrode plate 5. FIG. 3B is a plan view of the negative electrode plate 5. The negative electrode plate 5 includes, at an end portion on one side in a short-side direction, a negative-electrode-core-body exposure portion having a predetermined width and on which the negative electrode active material layer 5b is not disposed.

The positive-electrode-core-body exposure portion of the positive electrode plate 4 and the negative-electrode-core-body exposure portion of the negative electrode plate 5 that are obtained by the aforementioned method are displaced from each other so as not to overlap the active material layer of the opposite electrode, and the positive electrode plate 4 and the negative electrode plate 5 are wound with a porous polyethylene separator interposed therebetween into a flat shape. Consequently, the flat wound electrode body 3 that includes the positive electrode core body 4a layered at one end portion and the negative electrode core body 5a layered at the other end portion is obtained.

### Attachment of Components to Sealing Plate

Next, a method of attaching the positive electrode current collector 6, the positive electrode terminal 7, the negative electrode current collector 8, and the negative electrode terminal 9 to the sealing plate 2 will be described with respect to the positive electrode side as an example. The same method as that for the positive electrode side is applied to the attachment on the negative electrode side.

The external insulating member 11 is arranged on the sealing plate 2 on the external side of the battery, and the internal insulating member 10 and the positive electrode current collector 6 are arranged on the sealing plate 2 on the internal side of the battery. Next, the insertion portion of the positive electrode terminal 7 is inserted from the external side of the battery into a hole provided in each of the external insulating member 11, the sealing plate 2, the internal insulating member 10, and the positive electrode current collector 6. Next, a leading end portion of the insertion portion is crimped to the positive electrode current collector 6. Consequently, the positive electrode terminal 7, the external insulating member 11, the sealing plate 2, the internal insulating member 10, and the positive electrode current collector 6 are integrally fixed. Preferably, the crimped leading end portion of the insertion portion of the positive electrode terminal 7 is welded to the positive electrode current collector 6.

### Attachment of Current Collector to Electrode Body

Next, a method of attaching the positive electrode current collector 6 and the negative electrode current collector 8 to the wound electrode body 3 will be described.

(Connection between Positive Electrode Current Collector and Positive Electrode Core Body)

The positive electrode current collector 6 having a thickness of 0.8 mm and made of aluminum is arranged on an outer surface on one side of a portion at which the positive electrode core body 4a having a thickness of 15 μm and made of aluminum is layered into 60 layers.

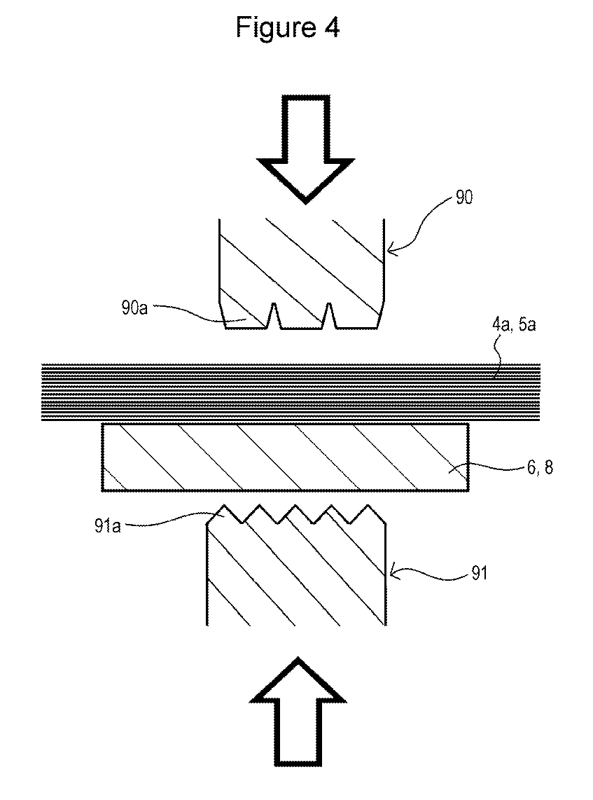

Next, as illustrated in FIG. 4, the layered positive electrode core body 4a and the positive electrode current collector 6 are held between a horn 90 and an anvil 91 of an ultrasonic joining device. At this time, the horn 90 is arranged so as to be in contact with an outer surface of the layered positive electrode core body 4a. The anvil 91 is arranged so as to be in contact with a surface of the positive electrode current collector 6 opposite to a surface thereof in contact with the positive electrode core body 4a.

Next, the horn 90 is vibrated to thereby join the layers of the layered positive electrode core body 4a together and the positive electrode core body 4a and the positive electrode current collector 6 to each other. Conditions of ultrasonic joining are not particularly limited; however, ultrasonic joining is preferably performed at a horn load of 1000 N to 2500 N (100 kgf to 250 kgf), at a frequency of 19 kHz to 30 kHz, and for a joining time of 200 ms to 500 ms. When the frequency is 20 kHz, the horn amplitude is preferably set within a range of 50% to 90%.

Oxide films of surfaces of the positive electrode core body 4a and the positive electrode current collector 6 are removed as a result of friction that is produced by applying ultrasonic vibrations to the layered positive electrode core body 4a and the positive electrode current collector 6, thereby tightly joining the layers of the positive electrode core body 4a together and the positive electrode core body 4a and the positive electrode current collector 6 to each other by solid phase bonding.

The horn 90 is provided with a plurality of horn projections 90a formed on a surface that comes into contact with the positive electrode core body 4a. Ultrasonic joining is performed in a state in which the horn projections 90a have intruded into the layered positive electrode core body 4a.

The anvil 91 is provided with a plurality of anvil projections 91a formed on a surface that comes into contact with the positive electrode current collector 6. Ultrasonic joining is performed in a state in which the anvil projections 91a have intruded into the positive electrode current collector 6.

As a result of the layered positive electrode core body 4a and the positive electrode current collector 6 being joined to each other by ultrasonic joining, a joined portion 80 that is joined to the positive electrode current collector 6 is formed on the layered positive electrode core body 4a. The joined portion 80 includes a plurality of recesses and projections. The positive electrode current collector 6 includes, in a region to which the layered positive electrode core body 4a is joined, a plurality of current collector recesses 6x that are formed on a surface opposite to a surface on which the layered positive electrode core body 4a is arranged.

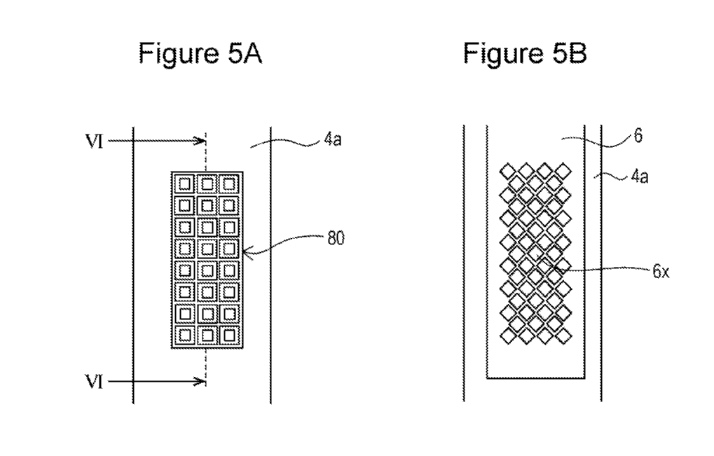

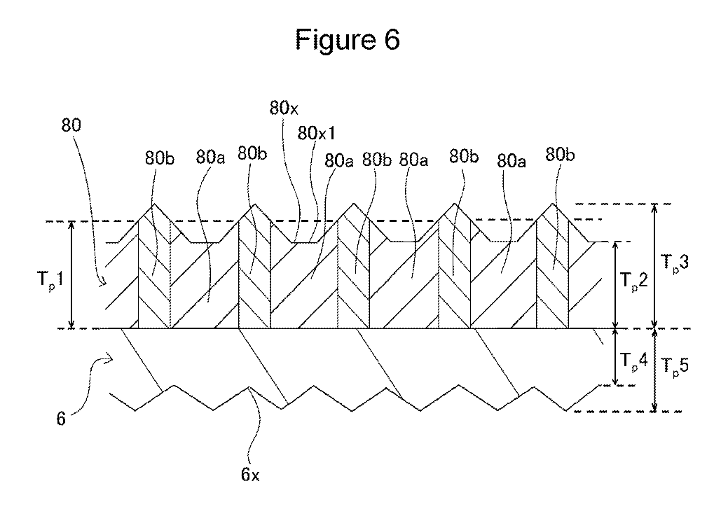

FIG. 6 is a sectional view taken along line VI-VI in FIG. 5A. The product of the thickness of one layer of the positive electrode core body 4a at a portion not joined to the positive electrode current collector 6 (for example, a portion of the positive electrode core body 4a facing the positive electrode current collector 6 and not joined to the positive electrode current collector 6) and the number of the layers of the positive electrode core body 4a at the joined portion 80 is denoted as Tₚ1 The joined portion 80 of the layered positive electrode core body 4a includes a first region 80a having a thickness less than Tₚ1 and a second region 80b having a thickness more than Tₚ1. With such a configuration, it is possible to suppress occurrence of the damage or fracture of the positive electrode core body 4a and to tightly join the positive electrode core body 4a and the positive electrode current collector 6 to each other.

The thickness of a thinnest portion of the first region 80a is denoted as Tₚ2. The thickness of a thickest portion of the second region 80b is denoted as Tₚ3. The thickness Tₚ2 and the thickness Tₚ3 are controlled to satisfy proper peel strength, conduction, and appearance of ultrasonic-joined portions by adjusting the setting of the horn load, the frequency, the horn amplitude, and the joining time of the ultrasonic joining device. Preferably, the thickness Tₚ2 and the thickness Tₚ3 are controlled by adjusting the setting of, in particular, the horn amplitude.

The layers of the positive electrode core body 4a are joined together by diffusion bonding in the first region 80a. Preferably, the layers of the positive electrode core body 4a are joined together by solid phase bonding. Preferably, in the first region 80a, a region that has not melted and solidified during ultrasonic joining is present at a center portion of one layer of the positive electrode core body 4a in the thickness direction. With such a configuration, it is possible to effectively suppress the thickness of the thinnest portion of the first region 80a from excessively decreasing and it is possible to more effectively suppress occurrence of the damage or fracture of the positive electrode core body 4a. For example, the thickness of one layer of the positive electrode core body 4a before ultrasonic joining is denoted as Tₚx. With respect to the first region 80a, the distance between a diffusion layer on one surface side and a diffusion layer on the other surface side in the thickness direction of the positive electrode core body 4a after ultrasonic joining is denoted as Tᵣy. Here, Tₚy/Tₚx is preferably 0.5 or more, more preferably 0.6 or more, and furthermore preferably 0.8 or more.

Preferably, the number of the current collector recesses 6x formed in the positive electrode current collector 6 is more than the number of core body recesses 80x formed in the first region 80a.

Preferably, the joining strength (peel strength) between the layers of the positive electrode core body 4a in the first region 80a is more than the joining strength (peel strength) between the layers of the positive electrode core body 4a in the second region 80b. With such a configuration, it is possible to more effectively suppress occurrence of the damage or fracture of the positive electrode core body 4a while tightly joining the layered positive electrode core body 4a and the positive electrode current collector 6 to each other.

Preferably, each core body recess 80x formed in the first region 80a includes a flat portion 80x1 at the bottom thereof. Such a configuration accelerates friction behavior during ultrasonic joining in a portion that becomes the first region 80a, which more tightly joins the layers of the positive electrode core body 4a together and the positive electrode core body 4a and the positive electrode current collector 6 to each other.

When viewed in the layered direction of the positive electrode core body 4a, the area of one flat portion 80x1 is preferably 0.01 mm² to 0.60 mm², more preferably 0.01 mm² to 0.25 mm², and furthermore preferably 0.01 mm² to 0.16 mm².

Preferably, the current collector recesses 6x formed in the positive electrode current collector 6 have no flat portion at the bottom thereof; or, preferably, the area of one flat portion formed at the bottom of each current collector recess 6x formed in the positive electrode current collector 6 is less than the area of one flat portion 80x1.

Preferably, the second region 80b tapers in a direction away from the positive electrode current collector 6. With such a configuration, the metal constituting the portion that becomes the first region 80a expands during ultrasonic joining, which enables a portion that becomes the second region 80b to easily receive the expanded metal constituting the portion that becomes the first region 80a. Accordingly, it is possible to more effectively suppress occurrence of the damage or fracture of the positive electrode core body 4a. Preferably, a portion that includes a top portion of a projection formed between one core body recess 80x that is formed in the first region 80a and another core body recess 80x becomes the second region 80b.

In the second region 80b, the joining strength between the layers of the positive electrode core body 4a may be reduced in the direction away from the positive electrode current collector 6. With such a configuration, it is possible to more effectively suppress occurrence of the damage or fracture of the positive electrode core body 4a. For example, in the second region 80b, a gap may be formed between the layers of the positive electrode core body 4a in the vicinity of the outer surface of the positive electrode core body 4a in the layered direction.

When the positive electrode core body 4a is made of aluminum or an aluminum alloy, Tₚ2/Tₚ1 is preferably 0.70 to 0.95 and Tₚ3/Tₚ1 is preferably 1.02 to 1.53 where Tₚ2 is the thickness of the thinnest portion of the first region 80a and Tₚ3 is the thickness of the thickest portion of the second region 80b. With such a configuration, it is possible to more reliably suppress occurrence of the damage or fracture of the positive electrode core body 4a and to more tightly join the positive electrode core body 4a and the positive electrode current collector 6 to each other. Preferably, Tₚ3/Tₚ1 is 1.05 to 1.23.

A difference (Tₚ3−Tₚ2) between the thickness Tₚ3 of the thickest portion of the second region 80b and the thickness Tₚ2 of the thinnest portion of the first region 80a is preferably 0.8 mm or less, more preferably 0.1 mm to 0.5 mm, and furthermore preferably 0.2 mm to 0.4 mm.

Preferably, ultrasonic joining is performed such that an expansion ratio X as a result of the ultrasonic joining is 20% or less with respect to, of the layers of the layered positive electrode core body 4a, a layer that is farthest from the positive electrode current collector 6 in the first region 80a. Consequently, it is possible to more reliably suppress occurrence of the damage or fracture of the positive electrode core body 4a. The expansion ratio X is calculated as (length of positive electrode core body 4a after ultrasonic joining−length of positive electrode core body 4a before ultrasonic joining)/(length of positive electrode core body 4a before ultrasonic joining)×100.

Preferably, ultrasonic joining is performed such that an expansion ratio Y as a result of the ultrasonic joining is less than the expansion ratio X with respect to, of the layers of the layered positive electrode core body 4a, a layer that is farthest from the positive electrode current collector 6 in the second region 80b. Consequently, it is possible to more reliably suppress occurrence of the damage or fracture of the positive electrode core body 4a. Preferably, ultrasonic joining is performed such that the expansion ratio Y as a result of the ultrasonic joining is 5% or less with respect to, of the layers of the layered positive electrode core body 4a, a layer that is farthest from the positive electrode current collector 6 in the second region 80b.

Preferably, the thickness Tₚ2 of the thinnest portion of the first region 80a is more than a thickness Tₚ4 of a thinnest portion of a portion of the positive electrode current collector 6 joined to the positive electrode core body 4a.

The product of the thickness of one layer of the positive electrode core body 4a at the portion not joined to the positive electrode current collector 6 and the number of the layers of the positive electrode core body 4a at the joined portion 80 is denoted as Tₚ1.

The thickness of the thinnest portion of the first region 80a is denoted as Tₚ2. The thickness of the thinnest portion of the portion of the positive electrode current collector 6 joined to the positive electrode core body 4a is denoted as Tₚ4.

The thickness of a thickest portion of the portion of the positive electrode current collector 6 joined to the positive electrode core body 4a is denoted as Tₚ5.

Preferably, (Tₚ5−Tₚ4) is more than (Tₚ1−Tₚ2).

When the positive electrode core body 4a is made of aluminum or an aluminum alloy, the thickness of the positive electrode core body 4a is preferably 5 μm to 30 μm, more preferably 8 μm to 25 μm, and furthermore preferably 10 μm to 20 μm.

In addition, when the positive electrode core body 4a is made of aluminum or an aluminum alloy, the number of the layers of the positive electrode core body 4a is preferably 20 to 100, more preferably 30 to 90, and furthermore preferably 40 to 80.

When the positive electrode current collector 6 is made of aluminum or an aluminum alloy, the thickness of the positive electrode current collector 6 is preferably 0.3 mm to 2 mm, more preferably 0.5 mm to 1.5 mm, and furthermore preferably 0.8 mm to 1.5 mm.

(Connection between Negative Electrode Current Collector and Negative Electrode Core Body)

The negative electrode current collector 8 having a thickness of 0.8 mm and made of copper is arranged on an outer surface on one side of a portion at which the negative electrode core body 5a having a thickness of 8 μm and made of copper is layered into 62 layers.

Next, as illustrated in FIG. 4, the layered negative electrode core body 5a and the negative electrode current collector 8 are held between the horn 90 and the anvil 91 of the ultrasonic joining device. At this time, the horn 90 is arranged so as to be in contact with an outer surface of the layered negative electrode core body 5a. The anvil 91 is arranged so as to be in contact with a surface of the negative electrode current collector 8 opposite to a surface thereof in contact with the negative electrode core body 5a.

Next, the horn 90 is vibrated to thereby join the layers of the layered negative electrode core body 5a together and the negative electrode core body 5a and the negative electrode current collector 8 to each other. Conditions of ultrasonic joining are not particularly limited; however, ultrasonic joining is preferably performed at a horn load of 1000 N to 2500 N (100 kgf to 250 kgf), at a frequency of 19 kHz to 30 kHz, and for a joining time of 300 ms to 800 ms. When the frequency is 20 kHz, the horn amplitude is preferably set within a range of 60% to 95%.

Oxide films of surfaces of the negative electrode core body 5a and the negative electrode current collector 8 are removed as a result of friction that is produced by applying ultrasonic vibrations to the layered negative electrode core body 5a and the negative electrode current collector 8, thereby tightly joining the layers of the negative electrode core body 5a together and the negative electrode core body 5a and the negative electrode current collector 8 to each other by solid phase bonding.

The horn 90 is provided with a plurality of horn projections 90a formed on a surface that comes into contact with the negative electrode core body 5a. Ultrasonic joining is performed in a state in which the horn projections 90a have intruded into the layered negative electrode core body 5a.

The anvil 91 is provided with a plurality of anvil projections 91a formed on a surface that comes into contact with the negative electrode current collector 8. Ultrasonic joining is performed in a state in which the anvil projections 91a have intruded into the negative electrode current collector 8.

As a result of the layered negative electrode core body 5a and the negative electrode current collector 8 being joined to each other by ultrasonic joining, a joined portion 81 that is joined to the negative electrode current collector 8 is formed on the layered negative electrode core body 5a. The joined portion 81 includes a plurality of recesses and projections. The negative electrode current collector 8 includes, in a region to which the layered negative electrode core body 5a is joined, a plurality of current collector recesses 8x that are formed on a surface opposite to a surface on which the layered negative electrode core body 5a is arranged.

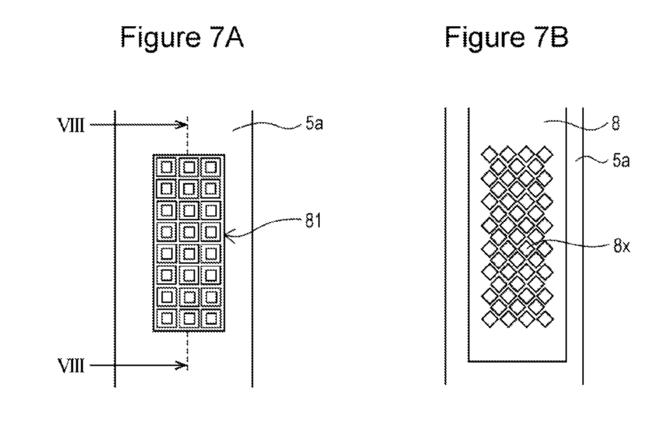

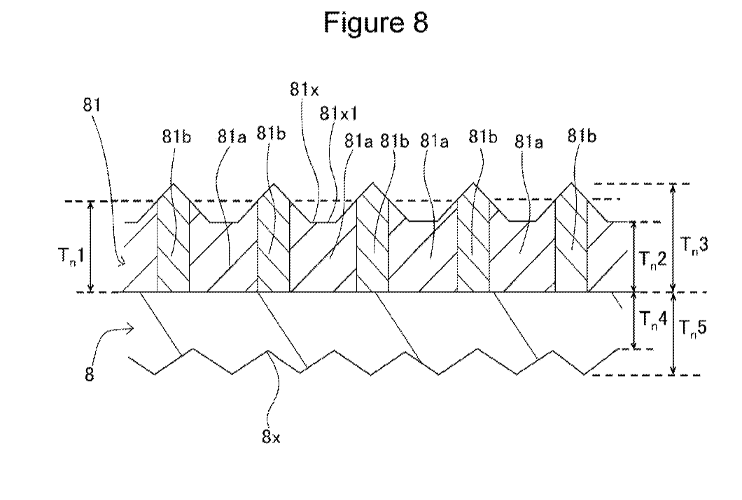

FIG. 8 is a sectional view taken along line VIII-VIII in FIG. 7A.

The product of the thickness of one layer of the negative electrode core body 5a at a portion not joined to the negative electrode current collector 8 (for example, a portion of the negative electrode core body 5a facing the negative electrode current collector 8 and not joined to the negative electrode current collector 8) and the number of the layers of the negative electrode core body 5a at the joined portion 81 is denoted as Tₙ1. The joined portion 81 of the layered negative electrode core body 5a includes a first region 81a having a thickness less than Tₙ1 and a second region 81b having a thickness more than Tₙ1. With such a configuration, it is possible to suppress occurrence of the damage or fracture of the negative electrode core body 5a and to tightly join the negative electrode core body 5a and the negative electrode current collector 8 to each other.

The thickness of a thinnest portion of the first region 81a is denoted as Tₙ2.

The thickness of a thickest portion of the second region 81b is denoted as T₃. The thickness Tₙ2 and the thickness Tₙ3 are controlled to satisfy proper peel strength, conduction, and appearance of ultrasonic-joined portions by adjusting the setting of the horn load, the frequency, the horn amplitude, and the joining time of the ultrasonic joining device. Preferably, the thickness Tₙ2 and the thickness Tₙ3 are controlled by adjusting the setting of, in particular, the horn amplitude.

The layers of the negative electrode core body 5a are joined together by diffusion bonding in the first region 81a. Preferably, the layers of the negative electrode core body 5a are joined together by solid phase bonding. Preferably, in the first region 81a, a region that has not melted and solidified during ultrasonic joining is present at a center portion of one layer of the negative electrode core body 5a in the thickness direction. With such a configuration, it is possible to effectively suppress the thickness of the thinnest portion of the first region 81a from excessively decreasing and it is possible to more effectively suppress occurrence of the damage or fracture of the negative electrode core body 5a. For example, the thickness of one layer of the negative electrode core body 5a before ultrasonic joining is denoted as Tₙx. With respect to the first region 81a, the distance between a diffusion layer on one surface side and a diffusion layer on the other surface side in the thickness direction of the negative electrode core body 5a after ultrasonic joining is denoted as Tₙy. Here, Tₙy/Tₙx is preferably 0.5 or more, more preferably 0.6 or more, and furthermore preferably 0.8 or more.

Preferably, the number of the current collector recesses 8x formed in the negative electrode current collector 8 is more than the number of core body recesses 81x formed in the first region 81a.

Preferably, the joining strength (peel strength) between the layers of the negative electrode core body 5a in the first region 81a is more than the joining strength (peel strength) between the layers of the negative electrode core body 5a in the second region 81b. With such a configuration, it is possible to more effectively suppress occurrence of the damage or fracture of the negative electrode core body 5a while tightly joining the layered negative electrode core body 5a and the negative electrode current collector 8 to each other.

Preferably, each core body recess 81x formed in the first region 81a includes a flat portion 81x1 at the bottom thereof. Such a configuration accelerates friction behavior during ultrasonic joining in a portion that becomes the first region 81a, which more tightly joins the layers of the negative electrode core body 5a together and the negative electrode core body 5a and the negative electrode current collector 8 to each other.

When viewed in the layered direction of the negative electrode core body 5a , the area of one flat portion 81x1 is preferably 0.01 mm² to 0.60 mm², more preferably 0.01 mm² to 0.25 mm², and furthermore preferably 0.01 mm² to 0.16 mm².

Preferably, the current collector recesses 8x formed in the negative electrode current collector 8 have no flat portion at the bottom thereof; or, preferably, the area of one flat portion formed at the bottom of each current collector recess 8x formed in the negative electrode current collector 8 is less than the area of one flat portion 81x1.

Preferably, the second region 81b tapers in a direction away from the negative electrode current collector 8. With such a configuration, the metal constituting the portion that becomes the first region 81a expands during ultrasonic joining, which enables a portion that becomes the second region 81b to easily receive the expanded metal constituting the portion that becomes the first region 81a. Accordingly, it is possible to more effectively suppress occurrence of the damage or fracture of the negative electrode core body 5a. Preferably, a portion that includes a top portion of a projection that is formed between one core body recess 81x formed in the first region 81a and another core body recess 81x becomes the second region 81b.

In the second region 81b, the joining strength between the layers of the negative electrode core body 5a may be reduced in the direction away from the negative electrode current collector 8. With such a configuration, it is possible to more effectively suppress occurrence of the damage or fracture of the negative electrode core body 5a. For example, in the second region 81b, a gap may be formed between the layers of the negative electrode core body 5a in the vicinity of the outer surface of the negative electrode core body 5a in the layered direction.

When the negative electrode core body 5a is made of copper or a copper alloy, Tₙ2/Tₙ1 is preferably 0.70 to 0.95 and Tₙ3/Tₙ1 is preferably 1.10 to 1.98 where Tₙ2 is the thickness of the thinnest portion of the first region 81a and Tₙ3 is the thickness of the thickest portion of the second region 81b. With such a configuration, it is possible to more reliably suppress occurrence of the damage or fracture of the negative electrode core body 5a and to more tightly join the negative electrode core body 5a and the negative electrode current collector 8 to each other. Preferably, Tₙ3/Tₙ1 is 1.27 to 1.42.

A difference (Tₙ3−Tₙ2) between the thickness Tₙ3 of the thickest portion of the second region 81b and the thickness Tₙ2 of the thinnest portion of the first region 81a is preferably 0.8 mm or less, more preferably 0.1 mm to 0.5 mm, and furthermore preferably 0.2 mm to 0.4 mm.

Preferably, ultrasonic joining is performed such that the expansion ratio Y as a result of the ultrasonic joining is 20% or less with respect to, of the layers of the layered negative electrode core body 5a, a layer that is farthest from the negative electrode current collector 8 in the first region 81a. Consequently, it is possible to more reliably suppress occurrence of the damage or fracture of the negative electrode core body 5a. The expansion ratio Y is calculated as (length of negative electrode core body 5a after ultrasonic joining−length of negative electrode core body 5a before ultrasonic joining)/(length of negative electrode core body 5a before ultrasonic joining)×100.

Preferably, ultrasonic joining is performed such that the expansion ratio Y as a result of the ultrasonic joining is less than the expansion ratio X with respect to, of the layers of the layered negative electrode core body 5a, a layer that is farthest from the negative electrode current collector 8 in the second region 81b. Consequently, it is possible to more reliably suppress occurrence of the damage or fracture of the negative electrode core body 5a. Preferably, ultrasonic joining is performed such that the expansion ratio Y as a result of the ultrasonic joining is 5% or less with respect to, of the layers of the layered negative electrode core body 5a, a layer that is farthest from the negative electrode current collector 8 in the second region 81b.

Preferably, the thickness Tₙ2 of the thinnest portion of the first region 81a is more than a thickness Tₙ4 of a thinnest portion of a portion of the negative electrode current collector 8 joined to the negative electrode core body 5a.

The product of the thickness of one layer of the negative electrode core body 5a at the portion not joined to the negative electrode current collector 8 and the number of the layers of the negative electrode core body 5a at the joined portion 81 is denoted as Tₙ1.

The thickness of the thinnest portion of the first region 81a is denoted as Tₙ2.

The thickness of the thinnest portion of the portion of the negative electrode current collector 8 joined to the negative electrode core body 5a is denoted as Tₙ4.

The thickness of a thickest portion of the portion of the negative electrode current collector 8 joined to the negative electrode core body 5a is denoted as Tₙ5.

Preferably, (Tₙ5−Tₙ4) is more than (Tₙ1−Tₙ2).

When the negative electrode core body 5a is made of copper or a copper alloy, the thickness of the negative electrode core body 5a is preferably 5 μm to 30 μm, more preferably 5 μm to 20 μm, and furthermore preferably 6 μm to 15 μm.

In addition, when the negative electrode core body 5a is made of copper or a copper alloy, the number of the layers of the negative electrode core body 5a is preferably 20 to 100, more preferably 30 to 90, and furthermore preferably 40 to 80.

When the negative electrode current collector 8 is made of copper or a copper alloy, the thickness of the negative electrode current collector 8 is preferably 0.3 mm to 2 mm, more preferably 0.5 mm to 1.5 mm, and furthermore preferably 0.8 mm to 1.0 mm.

### EXAMPLES 1 to 5

The positive electrode core body 4a having a thickness of 15 μm and made of aluminum was layered into 60 layers and joined to the positive electrode current collector 6 having a thickness of 0.8 mm and made of aluminum by ultrasonic joining under different conditions in each of Examples 1 to 5. Conditions and results in Examples 1 to 5 are indicated in Table 1.

In Table 1, “horn load (N)”, “horn amplitude (%)”, “joining time (ms)” are conditions of ultrasonic joining. The frequency in each example is 20 kHz.

The horn 90 that includes the horn projections 90a having a height of 0.26 mm and the anvil 91 that includes the anvil projections 91a having a height of 0.36 mm were employed in each of Examples 1 to 5.

The resistance value of the joined portions was measured by the following method.

The AC resistance value between a portion of the positive electrode core body 4a in contact with the horn projections 90a of the horn 90 and a portion of the positive electrode current collector 6 in contact with the anvil projections 91a of the anvil 91 was measured.

TABLE 1

| | | | | | | | Resistance |
|---|---|---|---|---|---|---|---|
| | | | | Horn | | | Value of |
| | | | Horn | Ampli- | Joining | Fracture | Joined |
| | Tₚ2/ | Tₚ3/ | Load | tude | Time | of Core | Portion |
| | Tₚ1 | Tₚ1 | (N) | (%) | (ms) | Body | (mΩ) |
| Example 1 | 0.95 | 1.23 | 1600 | 70 | 300 | none | 0.008 |
| Example 2 | 0.90 | 1.19 | 1600 | 74 | 300 | none | 0.006 |
| Example 3 | 0.85 | 1.14 | 1600 | 77 | 300 | none | 0.006 |
| Example 4 | 0.75 | 1.07 | 1600 | 81 | 300 | none | 0.005 |
| Example 5 | 0.70 | 1.05 | 1600 | 83 | 300 | none | 0.005 |

As indicated in Table 1, it was confirmed that, when Tₚ2/Tₚ1 is 0.70 to 0.95 and Tₚ3/Tₚ1 is 1.05 to 1.23, joining between the layers of the positive electrode core body 4a and joining between the positive electrode core body 4a and the positive electrode current collector 6 are tight with no fracture occurring in the positive electrode core body 4a.

### EXAMPLES 6 to 8

The negative electrode core body 5a having a thickness of 8 μm and made of copper was layered into 62 layers and joined to the negative electrode current collector 8 having a thickness of 0.8 mm and made of copper by ultrasonic joining under different conditions in each of Examples 6 to 8. Conditions and results in Examples 6 to 8 are indicated in Table 2.

In Table 2, “horn load (N)”, “horn amplitude (%)”, and “joining time (ms)” are conditions of ultrasonic joining. The frequency in each example is 20 kHz.

The horn 90 that includes the horn projections 90a having a height of 0.26 mm and the anvil 91 that includes the anvil projections 91a having a height of 0.36 mm were employed in each of Examples 6 to 8.

The resistance value of the joined portions was measured by the following method.

The AC resistance value between a portion of the negative electrode core body 5a in contact with the horn projections 90a of the horn 90 and a portion of the negative electrode current collector 8 in contact with the anvil projections 91a of the anvil 91 was measured.

TABLE 2

| | | | | | | | Resistance |
|---|---|---|---|---|---|---|---|
| | | | | Horn | | | Value of |
| | | | Horn | Ampli- | Joining | Fracture | Joined |
| | Tₙ2/ | Tₙ3/ | Load | tude | Time | of Core | Portion |
| | Tₙ1 | Tₙ1 | (N) | (%) | (ms) | Body | (mΩ) |
| Example 6 | 0.90 | 1.42 | 1800 | 75 | 600 | none | 0.003 |
| Example 7 | 0.85 | 1.37 | 1800 | 80 | 600 | none | 0.002 |
| Example 8 | 0.75 | 1.27 | 1800 | 85 | 600 | none | 0.002 |

As indicated in Table 2, it was confirmed that, when Tₙ2/Tₙ1 is 0.75 to 0.90 and Tₙ3/Tₙ1 is 1.27 to 1.42, joining between the layers of the negative electrode core body 5a and joining between the negative electrode core body 5a and the negative electrode current collector 8 are tight with no fracture occurring in the negative electrode core body 5a.

### Other

The electrode body may be a layered electrode body in which a plurality of positive electrode plates and a plurality of negative electrode plates are layered or may be a wound electrode body in which a belt-shaped positive electrode plate and a belt-shaped negative electrode plate are wound.

An example in which a core body is layered by winding a belt-shaped core-body exposure portion is presented for the aforementioned embodiment; however, the example is a non-limiting example. A plurality of core-body exposure portions may be formed in a belt-shaped electrode plate and the plurality of core-body exposure portions may be layered to form the layered state of the core body. Moreover, in a layered electrode body that includes a plurality of positive electrode plates and a plurality of negative electrode plates, core bodies of each of the electrode plates may be layered.

The shape of the horn projections 90a and the shape of the anvil projections 91a are not particularly limited. Examples of the shape of the horn projections 90a and the shape of the anvil projections 91a include a conical shape, a truncated-conical shape, a pyramidal shape, a truncated-pyramidal shape, a cylindrical shape, and a spherical shape. The shape of the horn projections 90a and the shape of the anvil projections 91a may coincide or may not coincide with each other. The number of the horn projections 90a and the number of the anvil projections 91a may be adjusted, as appropriate.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A secondary battery comprising:
a first electrode plate including a first core body made of metal and a first active material layer disposed on the first core body, the first core body being layered; and
a first current collector made of metal and joined to the layered first core body,
wherein the layered first core body includes a joined portion that is joined to the first current collector and
wherein, when a product of a thickness of one layer of the first core body at a portion not joined to the first current collector and the number of layers of the first core body at the joined portion is T1, the joined portion includes a first region having a thickness less than T1 and a second region having a thickness more than T1 in a layered direction of the first core body.

2. The secondary battery according to claim 1,
wherein the first region includes a recess and
wherein the recess includes a flat portion at a bottom thereof.

3. The secondary battery according to claim 1, wherein the second region tapers in a direction away from the first current collector.

4. The secondary battery according to claim 1,
wherein the first core body is made of aluminum or an aluminum alloy and
wherein, when a thickness of a thinnest portion of the first region is T2 and a thickness of a thickest portion of the second region is T3, T2/T1 is 0.70 to 0.95 and T3/T1 is 1.02 to 1.53.

5. The secondary battery according to claim 1,
wherein the first core body is made of copper or a copper alloy and
wherein, when a thinnest portion of the first region is T2 and a thickest portion of the second region is T3, T2/T1 is 0.75 to 0.90 and T3/T1 is 1.10 to 1.98.

6. The secondary battery according to claim 1, wherein, in the first region, the layers of the first core body in contact with each other are joined to each other by diffusion bonding.

7. The secondary battery according to claim 1, wherein, in the first region, the first core body includes, at a center portion in a thickness direction of the first core body, a portion that has not melted during joining of the first core body to the first current collector.

8. The secondary battery according to claim 1, wherein a joining strength between the layers of the first core body in the first region is higher than a joining strength between the layers of the first core body in the second region.

9. The secondary battery according to claim 1, wherein a thickness T2 of a thinnest portion of the first region is more than a thickness T4 of a thinnest portion of a portion of the first current collector joined to the first core body.

10. The secondary battery according to claim 1,
wherein, when a thickness of a thinnest portion of the first region is T2, a thickness of a thinnest portion of a portion of the first current collector joined to the first core body is T4, and a thickness of a thickest portion of a portion of the first current collector joined to the first core body is T5, (T5−T4) is more than (T1−T2).

11. A method of manufacturing a secondary battery including a first electrode plate that includes a first core body made of metal and a first active material layer disposed on the first core body, the first core body being layered, and a first current collector made of metal and joined to the layered first core body, the method comprising:
a first process of arranging the first current collector on an outer surface of the layered first core body; and
a second process of joining the layered first core body and the first current collector to each other by applying ultrasonic vibrations to the layered first core body and the first current collector held between an anvil and a horn, thereby providing the layered first core body with a joined portion joined to the first current collector,
wherein, when a product of a thickness of one layer of the first core body before being joined and the number of layers of the first core body at the joined portion is T1,
a first region having a thickness less than T1 and a second region having a thickness more than T1 are formed in the joined portion in a layered direction of the first core body as a result of the second process.

12. The method of manufacturing the secondary battery according to claim 11, wherein, in the second process, a portion of a metal constituting a portion that becomes the first region moves to a portion that becomes the second region.

13. The method of manufacturing the secondary battery according to claim 11, wherein, in the second process, a center portion of the first core body in a thickness direction does not melt in the first region, and surfaces of the layers of the first core body are joined to each other by diffusion bonding.

14. The method of manufacturing the secondary battery according to claim 11,
wherein the first region includes a recess and
wherein the recess includes a flat portion at a bottom thereof.

15. The method of manufacturing the secondary battery according to claim 11, wherein the second region tapers in a direction away from the first current collector.

16. The method of manufacturing the secondary battery according to claim 11,
wherein the first core body is made of aluminum or an aluminum alloy and
wherein, when a thickness of a thinnest portion of the first region is T2 and a thickness of a thickest portion of the second region is T3, T2/T1 is 0.70 to 0.95 and T3/T1 is 1.02 to 1.53.

17. The method of manufacturing the secondary battery according to claim 11,
wherein the first core body is made of copper or a copper alloy and
wherein when a thickness of a thinnest portion of the first region is T2 and a thickness of a thickest portion of the second region is T3, T2/T1 is 0.75 to 0.90 and T3/T1 is 1.10 to 1.98.

18. The method of manufacturing the secondary battery according to claim 11, wherein a joining strength between the layers of the first core body in the first region is higher than a joining strength between the layers of the first core body in the second region.

19. The method of manufacturing the secondary battery according to claim 11, wherein a thickness T2 of a thinnest portion of the first region is more than a thickness T4 of a thinnest portion of a portion of the first current collector joined to the first core body.

20. The method of manufacturing the secondary battery according to claim 11, wherein, when a thickness of a thinnest portion of the first region is T2, a thickness of a thinnest portion of a portion of the first current collector joined to the first core body is T4, and a thickness of a thickest portion of a portion of the first current collector joined to the first core body is T5, (T5−T4) is more than (T1−T2).
